(19) United States
(12) Patent Application Publication
(10) Pub. No.: US 2020/0397087 A1
(43) Pub. Date: Dec. 24, 2020

(54) Electronic Airflow Mask

(71) Applicants: Melissa Crenshaw, Evensville, IN (US); James Crenshaw, Evensville, IN (US)

(72) Inventors: Melissa Crenshaw, Evensville, IN (US); James Crenshaw, Evensville, IN (US)

(21) Appl. No.: 17/012,148

(22) Filed: Sep. 4, 2020

Related U.S. Application Data
(63) Continuation-in-part of application No. 16/865,987, filed on May 4, 2020.
(60) Provisional application No. 62/845,869, filed on May 10, 2019.

(51) Int. Cl. A42B 3/28; A62B 23/02; A41D 13/11; A62B 18/02

(52) U.S. Cl. CPC A42B 3/286; A62B 23/025; A41D 13/1161; A62B 18/02; A41D 13/113

(57) ABSTRACT

The present invention relates to an electronic airflow mask that allows a user to easily breathe through the mask, while reducing the potential of exposure to contamination from harmful airborne particles. The electronic airflow mask also minimizes the likelihood of the wearer experiencing skin damage, pressure points, pain or the like from wearing the mask for prolonged, uninterrupted periods of time. The electronic airflow mask includes a multi-speed fan powered by a power source to provide easy inhalation and exhalation of air by the user. The fan is disposed on a side of the mask, and its controls are readily accessible to the wearer.

### CROSS-REFERENCE TO RELATED APPLICATION

The present application is a continuation-in-part of U.S. patent application Ser. No. 16/865,987, which was filed on May 4, 2020 and claims priority to U.S. Provisional Patent Application No. 62/845,869, which was filed on May 10, 2019, both of which are incorporated herein by reference in their entirety.

### BACKGROUND

The present invention relates generally to an electronic air flow face mask. More specifically, the invention relates to a face mask that includes a mask body having a front hooked surface with ear loops, a loop-backed reusable and washable strap attached to the mask body, and an electric fan for improved airflow to the wearer. The electric fan is powered by a battery, which enables the intake of fresh air and the exhaust of released or expelled air through a filter body of the mask. The electronic air flow mask covers the nose and mouth of the wearer, and provides a proper amount of ventilation and air circulation, thereby reducing the issues related to poor air flow and circulation typically associated with prior art face masks. The electronic face mask of the present invention may be manufactured using plastic, cloth, non-woven material or PTE material, as per the preferences of the user or manufacturer. Accordingly, the present specification makes specific reference thereto. However, it is to be appreciated that aspects of the present invention are also equally applicable to other similar applications, devices and methods of manufacture.

Surgical and medical masks are designed to protect a user and those in close proximity to the user against contamination due to air-borne bacteria, pathogens, particulates, microbes, pollution and the like by minimizing or eliminating the number of air-borne bacteria, pathogens, particles, microbes, etc. which can be exhaled or inhaled by the user, and at the same time provides a relatively comfortable face covering which does not interfere with the actions and visibility of the user. Medical masks may also be employed by medical professionals to prevent contamination of a patient with the medical professional's nasal or oral bacteria that may result from the medical personnel talking, sneezing, or coughing during, for example, a patient encounter, office visit or a medical procedure. Medical masks also protect the user's mouth and nose from contacting splashes or sprays of the patient's blood or other body fluids, and from other airborne bacteria, microbes and pathogens. Additionally, despite their name, the use of medical masks is not limited to medical uses, and can also be used by non-medical personnel. For example, medical masks may be employed by private individuals in times of pandemics, high levels of pollution and other illness to help protect said individual from exposing others/becoming exposed to an airborne viral disease.

By way of background, existing surgical and/or face masks are typically made of a mask body that covers the nose and mouth of the user, and an elastic strap wrapped around and tied behind the head of the user to secure the mask to the user's head and face. The ties provide the mask with some adjustability as the user may position the ties to suit the user's comfort and provide a tight and snug fit to the face. Alternatively, some existing face masks may have a pair of closed loop elastic ties which loop around the user's ears, thereby securing the mask tightly yet comfortably, to the head of the user with minimal effort. However, both the strap based or ear loop-based mask designs suffer from certain deficiencies and present the opportunity for improper use of pre-existing masks. As an example, the strap forming ear loops are continuously pulling on the back of the user's ears to secure the mask to the face/head of the user, which creates a pressure spot that could lead to skin irritation, increased perspiration, and tension headaches near the affected area. Over time, this discomfort can lead to an individual taking off their mask to alleviate the discomfort, thereby inadvertently allowing the possibility of exposure to pathogens/bacteria to occur and defeating the overall purpose of using the mask.

Further, the face masks are effective only when the masks form a barrier or seal between the periphery of the mask and the face of the wearer. As a result of this sealing engagement between the mask and wearer's skin, substantially all air inhaled or exhaled by the wearer is forced to flow through the filter media of the face mask. As a result, these better-fitting filter masks can become hot and uncomfortable to the wearer during periods of long-term wear, or where weather conditions are not ideal (i.e., such as during hot and/or humid conditions), or where the air quality index (AQI) is very high, thereby creating hazardous conditions for breathing and making breathability of such masks a problem.

Some N95 face masks and respirators used as protective masks include one-way integrated passive valve to allow for exhaled breath (i.e., air) to escape. However, the efficacy of these passive valves in removing the warm and humid exhaled air is highly dependent upon the breathing depth and force applied by the user in exhaling the air. Further, the exhaled air must be forced to exit through the filters due to the limited window of the one-way valve, which oftentimes results in labored breathing and stress of the wearer. Additionally, moisture in the warm exhaled air condenses as it flows through the cold filters, and has a tendency of blocking the air channels within the filters, either partially or completely. The reduction in the size of the air channels directly increases air resistance, which can also cause breathing difficulties. Moreover, the inability to form an effective exhalation pathway while wearing the mask causes the hot and humid exhaled air to circulate within the respirator body thus creating discomfort to the wearer, and diminishing the value of the face mask device.

Therefore, there exists a long felt need in the art for an improved surgical or medical mask that prevents discomfort caused to the user by wearing ear loop-based masks. There also exists in the art a long felt need for an improved face mask that has a securing means that is more secure and easier to use than current face mask designs, in addition to being more comfortable than both tied and loop face mask designs. Additionally, there exists a long felt need in the art for a face mask having an active ventilation system that eliminates the breathability issues associated with prior art face masks, and that improves air circulation for the wearer. Further, there exists a long felt need in the art for a compact powering mechanism to provide power to the active ventilation system without adding significant weight or bulk to the overall device. Finally, there is a long felt need in the art for an affordable, easy to use and comfortable face mask that provides active air ventilation for the intake and exhaust of air, and protection against contamination due to air-borne bacteria, pathogens, microbes, particulates, and the like.

The present invention in one exemplary embodiment discloses an improved face mask that exhibits superior pathogen and harmful particulate filtering along with active air circulation and ventilation characteristics, and that can be worn comfortably by a wearer. More specifically, the electronic airflow mask has an ear loop with a strap and a body portion attached thereto. The body portion is further comprised of a face mask having an integrated and battery powered multi-speed airflow fan that is powered by a small battery, as well as a USB charging feature for the battery. The face mask portion may be comprised of a plastic, a cloth, a non-woven material or a PTE material, as per the preferences of the user and/or manufacturer.

In this manner, the improved protective face mask of the present invention accomplishes all of the forgoing objectives, thereby providing a user with a mask that prevents discomfort caused due to the irritation of having tight fitting ear loops or straps used for wearing the face mask. The improved face mask provides a means of active air circulation and ventilation for the wearer, thereby reducing or eliminating the breathability problems associated with traditional passive face masks. The face mask of the present invention also provides a user with a way to secure the mask that is more secure, comfortable and easier to use than current mask fastening mechanisms.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an improved protective face mask system. More specifically, the invention relates to a face mask that has a mask body with a front hooked surface, a pair of ear loops, a loop-backed adjustable strap assembly attached to the mask body, and an active air circulation/ventilation means. The electronic air flow mask covers the nose and mouth of a wearer, and actively provides proper air circulation and ventilation, thereby reducing suffocation and breathing difficulties associated with typical face masks. More specifically, the air flow mask of the present invention comprises a fan powered by a rechargeable battery, which enables the intake of fresh air and the exhaust of released breath (i.e., air) through an integrates filter body in the mask. The electronic face mask may be manufactured using a plastic, a cloth, a non-woven material, a PTE material, or any other suitable mask material that satisfies the needs and preferences of the user or manufacturer.

In another exemplary embodiment of the present invention, the electronic airflow mask is comprised of a mask body, a nose bridge over a joint section, an adjustable strap forming ear loops, a loop back support for the mask, and an integrated and active air circulation and ventilation device. The air circulation and ventilation device is comprised of a fan for the exhaust and intake of air through a filter material, wherein the fan is in electrical communication with, and powered by, a battery. The battery may be a single use battery or a rechargeable battery. The air circulation and ventilation device further comprises a USB or other suitable charging port for charging the rechargeable battery if one is used.

The nose bridge is preferably an elongated and deformable member, such as a metal strip (e.g., made from aluminum or other deformable material (also referred to as a “nose clip” or nose strip)), that conforms an upper portion of the mask to the nose, and holds it in place over the bridge of a wearer's nose. The mask body has a fold line which substantially divides the mask in half. When the mask is worn by the wearer, this fold or crease line is more or less aligned with an imaginary vertical line passing through the center of the forehead, the nose, and the center of the mouth, thereby creating substantially equal and symmetrical portions of the mask material. The mask body portion on the left side of the fold line is referred to as the left mask body, and the mask body portion on the right side of the fold line is referred to as the right mask body. The fan, battery, USB charging port and other components of the air circulation and ventilation device may be disposed on either body portion of the mask, such the left mask body or the right mask body, and generally in a position that does not interfere with the nose or mouth of the wearer, such as in a corner of the face mask, or along a side edge of the mask. In a further embodiment of the present invention, the airflow fan is electronic, and a controller for manipulating a speed of the fan is also disposed on the face mask. For example, the controller may be used for adjusting a direction of the fan, a speed of the fan and airflow as per the preferences of the user.

In one embodiment of the present invention, a method for securing and controlling operation of an electronic airflow face mask is disclosed. More specifically, the method comprises the steps of initially securing the ear loops of the present invention on each of the ears of the user, and placing the adjustable strap along the back of the user's head. Next, the mask body is positioned over the user's nose and mouth region. A battery powered fan is disposed on the face mask, and is controlled via a switch easily accessible to the user while the mask is being worn by the user. The switch allows the user to control, for example, the direction and speed of the fan. Additionally, the adjustable strap forms the ear loop and loop back strap or band structure, and its unique construction helps to reduce the discomfort caused by the securing mechanisms available in the face masks of the state of the art. Various strap adjusting mechanisms, such as a buckle, a cinch, etc., may also be used to provide for a more comfortable wearing experience.

In another embodiment of the present invention, an airflow ventilation assembly for a face mask is disclosed. The assembly comprises a power source, a fan coupled to the power source, a circuit for turning the fan ON or OFF, and a controller for manipulating the speed and/or direction of the fan. The fan, the power source, the circuit and the controller are each disposed on the mask body and easily accessible to the wearer, but do not interfere with the tasks being performed by the wearer. The electronic airflow face mask further provides a novel and superior securing means so as to cause no unnecessary discomfort to the wearer.

In a further embodiment of the present invention, the fan may be multi-directional and a switch may be employed to change the direction of the airflow. In operation, the fan draws the air exhaled by the wearer from within the interior volume of the mask, or draws fresh air into the interior volume of the mask providing greater comfort to the wearer. The drawing in or out of the air is performed through the filter, thereby preventing the user from encountering any undesirable pathogens, particulates, microbes, germs, etc. that may be airborne in the vicinity of the wearer.

In yet a still further embodiment of the present invention, an air flow regulating system for a face mask is disclosed, and comprises a cover material for filtering out particulate matter. More specifically, the cover material is comprised of first and second filter materials for filtering out material of at least 0.3 microns in size, and a perimeter formed from a strip of foam or adhesive that extends along each of the top, side and bottom edges of the mask. First and second straps connected to first and second ear loops are also provided for securing the cover material to a face of a wearer. The first and second straps having an adjustable fastening mechanism for tightening or loosening of the straps. Additionally, the air flow regulating system further comprises a fan, a battery, a switch and a controller, and is controllable by one of a manual or a remote actuator that is located on an exterior surface of the cover material for providing air flow into and out of the cover material.

In a still further embodiment of the presently described invention, a protective facial covering is described and includes a cover material sized and configured to cover a mouth and nose area of a wearer. The cover material has top and bottom edges and first and second side edges, thereby forming a perimeter, and a deformable strip comprised of a foam or adhesive that is positioned along an interior surface of said perimeter. The cover material is further comprised of inner and outer surfaces, a fan disposed on the outer surface of the cover material but extending to the interior surface, and at least one filter material is applied to the inner surface of the cover material. First and second ear loops are also provided, with an ear loop connected to each of the side edges of the cover material, wherein each ear loop has a top and bottom. First and second straps are also provided, wherein each of the straps are sized and configured to fit the wearer. More specifically, the first strap is attached to the top of each of the ear loops and the second strap is attached to the bottom of each of the ear loops.

As noted above, the improved air ventilation face mask may also comprise a foam lined structure extending around the perimeter of the face mask portion to help distribute the load of the face mask on the user's face. More specifically, the foam perimeter is preferably non-permeable to pathogens, bacteria, microbes, particulate, etc., and widens the surface area of the mask perimeter, thereby increasing the surface area that the pressure of the face mask is distributed across and reducing the overall pressure on the user's skin which can lead to skin irritation, damage and discomfort. In differing embodiments of the present invention, the foam perimeter may also be a skin-safe adhesive backing that aids the face mask in forming a better seal against the face of the user and preventing bacteria, microbes and the like from encroaching in from the edges of the mask.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one possible embodiment of the electronic airflow mask of the present invention being utilized by a user in accordance with the disclosed architecture;

FIG. 2 illustrates a left perspective view of one possible embodiment of the electronic airflow mask of the present invention being utilized by a user in accordance with the disclosed architecture; and

FIG. 3 illustrates a right perspective view of one possible embodiment of the electronic airflow mask of the present invention being utilized by a user in accordance with the disclosed architecture.

### DETAILED DESCRIPTION

The innovation presented here is now described with reference to the drawings, where like reference numerals are used to refer to like elements throughout the specification. In the following description, for purposes of explanation, numerous specific details are set forth in order to provide a thorough understanding thereof. It may be evident, however, that the innovation can be practiced without these individual specific details. In other instances, well-known structures and devices are shown in block diagram form in order to facilitate a description thereof.

As noted above, there exists a long felt need in the art for an improved protective, surgical or medical mask that reduces of prevents the discomfort typically associated with a user wearing a tight fitting, ear loop-based mask. There also exists in the art a long felt need for an improved face mask that has a securing strap that is more effective and easier to use than current protective or medical mask designs, in addition to being more comfortable than both tied and loop medical mask designs. Additionally, there exists a long felt need in the art for a face mask that reduces the breathability issues faced by users of conventional prior art masks due to sealing engagement between the mask and wearer's skin, and the lack of proper air circulation and ventilation. Moreover, there exists a long felt need in the art for a face mask that provides for active air circulation and ventilation to aid the breathing of the user, and for a relatively compact and inconspicuous powering mechanism to provide power to the circulation/ventilation assembly. Finally, there is a long felt need in the art for an affordable, easy to use and comfortable face mask that provides superior protection against contamination due to air-borne bacteria, microbes, pathogens, particulates, germs, and the like.

The subject matter disclosed and claimed herein, in one embodiment thereof, comprises an improved protective face mask. More specifically, the electronic air flow protective face mask is comprised of a mask body with a front hooked surface having ear loops and a loop-backed reusable and washable strap attached to the mask body. The mask body covers the nose and mouth of a wearer and provides enhanced and active air circulation and ventilation, thereby reducing the risk of suffocation and breathing difficulty encountered with typical face masks. More specifically, the air flow mask of the present invention includes a fan powered by a battery, which enables the intake of fresh air and the exhaust of released or exhaled breath through a filter body contained within the mask. The mask body of the electronic face mask may be manufactured using a plastic, a cloth, a non-woven material, a PTE material, or any other mask material that satisfies the needs and/or preferences of the user or manufacturer.

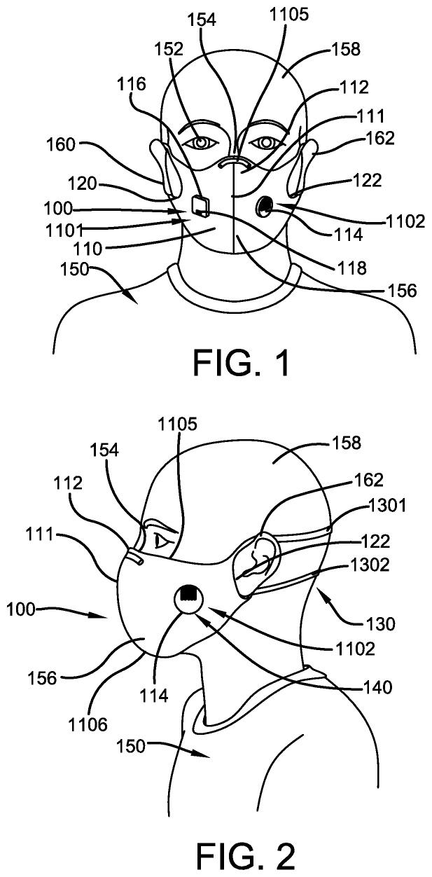

Referring initially to the drawings, FIG. 1 illustrates a front perspective view of one possible embodiment of the electronic airflow mask 100 of the present invention being utilized by a user 150 in accordance with the disclosed architecture. The electronic airflow mask 100 is preferably comprised of a mask body portion 110, an adjustable or elastic strap assembly 130, a formable nose bridge portion 112, a fan 114, a battery 116 and a USB port 118, each of which are described more fully below.

The mask body 110 is a generally cup shaped structure that fits comfortably over the nose 154 and mouth 156 of the user 150. Face mask bodies 110 of the present invention intended for use with an adult are preferably about 7 to about 13 inches in width (as measured between sides), and about 3 to about 5 inches in height (as measured between the top and bottom), and expandable. The mask body 110 further comprises a vertical fold line 111 that substantially divides the mask body 110 in half. When the mask 100 is worn by the wearer 150, this fold line or crease line 111, is more or less aligned with an imaginary vertical line passing through the center of the forehead, the nose 154, and the center of the mouth 156 of the user. The portion of the mask body 110 on the right side of the fold line 111 is referred to as the right mask body 1101, and the portion on the left side of the fold line 111 is referred to as the left mask body 1102. As further described below, the fan 114, battery 116, USB charging port 118 any other components may be disposed on either body portion of the mask 100, such as the right mask body 1101 or the left mask body 1102. Alternatively, the mask 100 may be offered with a fan 114 positioned on both sides of the mask body 110 to increase the amount of air circulation.

The nose bridge portion 112 of the mask body 110 is positioned over a top edge 1105 which runs across one side of the face to the other side over the nose 154. The nose bridge or nose-clip 112 includes an elongated deformable member that is positioned along the upper edge 1105 of the mask, and holds it in place once formed over the bridge of the wearer's nose 154. The wearer 150 may adjust the nose-bridge portion 112 depending on the size and contour of the wearer's nose to increase comfort and fit.

The mask body 110 is preferably comprised of a filter material, such as a non-woven fabric, a cloth, a PTE material, or any other suitable mask material which filters out pathogens, microbes, pollutants and other harmful germs from the air breathed in through the mask body 110, thereby providing pure or filtered air to the user's 150 respiratory system and preventing any type of cross contamination and the spread of diseases. More specifically, the material of the mask body 110 is preferably a particulate, bacteria filter, and is made from a non-woven, melt blown filter material that is comprised of 100% polypropylene or other suitable material. The mask body 110 acts as a fine particulate filter, thereby protecting the user 150 against at least 95% of any airborne dust, particulates, pathogens, or bacteria of 0.3+ microns sized particles. In differing embodiments of the electronic airflow mask 100, the material of the mask body 110 may include a coarse particulate filter that precedes the fine particulate filter to further protect the user 150 from larger/more coarse particulates. In this embodiment, the user may have first and second filter layers built into the mask 100. Further, the material of the mask body 110 may be made of cloth or PTE material which is sufficient capable of filtering harmful particles in the air and prevents the user from encountering any contamination and helps to avoid the spread of diseases.

A foam structure may also be located on a perimeter of the mask body 110 to increase the comfort of the wearer 150, and to act as a further barrier to airborne pathogens. Accordingly, the foam-based lining on the perimeter of the mask body 110 is preferably non-permeable to pathogens/bacteria. Moreover, the foam-based lining on the perimeter of the mask body 110 widens the surface area of the mask body 110 perimeter so that the pressure that the face mask 100 exerts against the skin on the face of the wearer 150 when worn is distributed across a wider surface area, thereby reducing the overall pressure of the mask body 110 on the user's skin which can lead to rashes, skin irritation or other skin related issues. In a further preferred embodiment of the present invention, the perimeter may also have a skin-safe adhesive backing that aids the mask body 110 in forming a better seal against the face of the user 150.

The mask body 110 further comprises an inner surface and an outer surface, in which the inner surface is facing the wearer 150 and the outer surface is facing away from the wearer 150. The outer surface of the mask body 110 can display without limitation, any number of patterns, colors, logos, text, slogans, trademarks, etc. desired by the wearer 150, thereby allowing the wearer 150 to easily customize the electronic airflow face mask 100 of the present invention for their own personal preference.

The strap assembly 130 forms a right ear loop 120 and a left ear loop 122, secured, respectively, on a right ear 160 and a left ear 162 of the user 150. The strap assembly 130 further includes a first strap and a second strap secured at the back of head 158 of the user 150. The strap assembly 130 can be secured and adjustably tightened by the user 150 using, for example, a ladder lock buckle or similar fastening mechanism. Other strap adjustment mechanisms may also be used. The strap assembly 130 may be manufactured using an elastic material, VELCRO strap or other material, as per the preferences of the user or specifications of the manufacturer.

FIG. 2 illustrates a left perspective view of one possible embodiment of the electronic airflow mask 100 of the present invention being utilized by a user 150 in accordance with the disclosed architecture. More specifically, the strap assembly 130 forms a left ear loop 122 which is secured on a left ear 162 of the user 150. A first strap 1301 and a second strap 1302 are also secured over the back of the head 158 of the user 150, which can be adjusted and secured to the head 158 using, for example, a ladder lock buckle or other strap adjusting mechanisms. The first strap 1301 is attached to a top edge 1105 of the mask body 110 in an extended position, and the second strap 1302 is attached to a bottom edge 1106 of the mask body 110 and extends around the backside of the head 158, thereby helping to secure the mask body 110 to the face of the wearer 150.

As best illustrated in FIG. 2, a fan 114 is disposed on a left side of a fold line 111, and a left portion of nose bridge 112 is disposed on the upper edge 1105 of left mask body 1102 to provide a better fit of the mask body 110 relative to the face of the user 150. When in operation, the fan 114 draws exhaled air out of the interior portion of the mask body 110, and draws fresh air into the interior portion of the mask body 110, thereby providing comfort to the wearer 150, and helps reduce breathability or respiratory issues encountered with traditional tight-fitting face masks. The fan 114 allows the wearer 150 to inhale and exhale with greater ease. More specifically, when the wearer 150 is inhaling while wearing the electronic face mask 100, the fan 114 provides the wearer with access to fresh and filtered air, which enters through the fan valve and through the mask body 110 filter material. Likewise, when the wearer 150 is exhaling while wearing the electronic face mask 100, the fan 114 effectively removes the hot and moist breath of the wearer 150, and expels the air to the outside atmosphere, which also prevents the fogging of eyeglasses if also worn by the wearer 150.

The fan 114 may be positioned over the outer surface of the mask body 110, or it may be removably or permanently affixed to the mask body 110 by using an adhesive, VELCRO®, or any other suitable type fastener. As previously stated, the fan 114 is preferably placed over the filter material of the mask body 110 to filter the air which enters the mask portion from the external environment through the fan 114. The fan 114 may also operate at different speeds or in different directions as per the needs and preferences of the user 150.

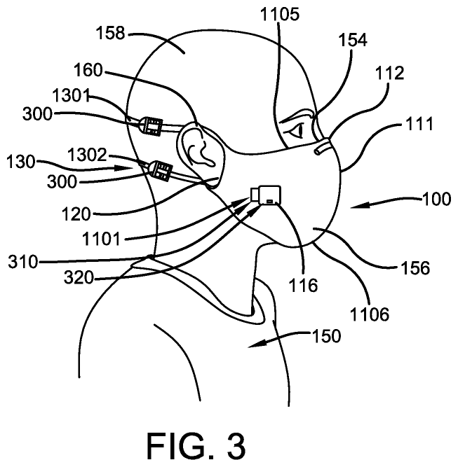

As best shown in FIGS. 1 and 3, the fan 114 is in electrical communication with a power source, such as battery 116, an electrical cord, a coil spring or other suitable power source, which supplies the power necessary to operate the fan 114. The connection between the fan 114 and the power source is preferably accomplished through an internal and relatively lightweight wiring mechanism. The fan 114 may also be connected to a controller (not shown) for manipulating the operation and speed of the fan 114. The controller connects the fan 114, power source, and other components of the mask 100. In a preferred embodiment of the present invention, the mask 100 may further comprise one or more sensors 140 to detect, for example, the humidity and temperature levels on the interior of the mask body 110 which, through the controller, may increase or decrease the speed of the fan 114. The sensor 140 may also be used to detect contamination levels of the mask filters to determine when the mask 100 needs to be discarded. The sensor 140 can also include a chemical sensor to determine permeability rates of the filter and the buildup of particular types of pathogens, pollutants or microbes. The mask 100 and sensor 140 may further include a color indicator to determine the age or number of days the mask 100 has been in use.

FIG. 3 illustrates a right perspective view of one possible embodiment of the electronic airflow mask 100 of the present invention being utilized by a user 150 in accordance with the disclosed architecture. As shown in FIG. 3, the strap assembly 130 forms a right ear loop 120 which is secured on a right ear 160 of the user 150. A first strap 1301 and a second strap 1302 are secured over the back of the head 158 of the user 150, and can be adjusted and secured to the head 158 using, for example, a ladder lock buckle 300 or other strap adjusting mechanisms. The first strap 1301 is attached to a top edge 1105 of the mask body 100 in an extended position, and the second strap 1302 is attached to a bottom edge 110 of the mask body 110 and extends around the back of the user's head 158. The strap assembly 300 of the present invention provides a comfortable face mask 100 securing mechanism, and prevents the pain or discomfort typically experienced by wearers of prior art masks. Ideally, the first and second straps 1301, 1302 are spaced apart by approximately 2 to 3 inches to ensure a secure attachment of the mask 100 to the wearer 150.

Referring now to FIG. 3, a right mask body 1101 has a power source 116, a USB charging port 118, a controller 310 and a button 320 disposed on a right side of the fold line 111. The right portion of the nose bridge 112 is disposed on the upper edge 1105 of right mask body 1101 to provide a better fit of the mask body 110 to the face of the user 150. Additionally, the power source 116 is connected to the fan 114, which is disposed on the left mask body 1102 to supply power for the operation of the fan 114.

The power source 116 is preferably a battery (e.g., single use or rechargeable), but is not limited thereto and other power supply sources can be used to operate the fan 114. More specifically, the power source 116 may contain one or more rechargeable batteries, which can be charged by utilizing the USB charging port 118. A USB cable may be connected to the USB charging port 118 of the mask 100 and to a power supplying source, such as a power bank, electrical outlet or other source. The batteries 116 can be charged at any time, including when the mask 100 is in operation and the fan 114 is turned ON. The mask 100 may be powered using nickel metal hydride (NiMH), nickel cadmium (NiCd) batteries, or any other type of batteries known in the state of the art to power small electronic devices.

The controller 310 is a central unit for the operation of the electronic airflow mask 100, and manages the operation of fan 114. The controller 310 connects the fan 114, button 320 and the power source 116, and enables the fan 114 to operate in accordance with the instructions of a user 150. The button 320 may be a push button, a switch, a touch button or any other means for activating or deactivating the fan 114. Additionally, the button 320 may be sewn to an outer surface of the mask body 110, or may be affixed thereto using any suitable adhesive including, without limitation, surgical adhesives or sealants marketed under the name DERMABOND® or the like.

The user 150 may push the button 320 once to turn on the fan 114, thereby allowing the fan 114 to expel hot and moist air from the interior of the mask body 110, as well as draw fresh air from the surrounding environment to enter inside the mask body 110 for the use's convenience and to aid the user 150 in breathing. The user 150 may push the button 320 a second time to turn off the fan 114. Turning the fan 114 off when not needed reduces power consumption and increases the life of the batteries 116 between charges.

Alternatively, the fan 114 may be controlled remotely by a corresponding application for the electronic airflow mask 100, such as a mobile application downloaded to a smartphone or other smart device. To that end, in a further embodiment of the present invention, the electronic airflow mask 100 may further comprise wireless connectivity modules (not shown) such as, but not limited to, Bluetooth, Wi-Fi, NFC, RFID, to wirelessly connect the airflow mask 100 to a smartphone or any other electronic device running an application to operate the mask 100 and control the speed and/or direction of the fan 114.

More specifically, as the user 150 presses the button 320 once, or wirelessly turns ON the fan 114 of the mask 100 by utilizing a corresponding smartphone application, a signal is sent to the controller 310, which further coordinates with the power source 116 to supply power to the fan 114 and start the airflow through the fan 114. When in operational mode, the fan 114 expels exhaled air out of the interior portion of the mask body 110, and/or draws fresh air into the interior portion of the mask body 110, thereby allowing the wearer 150 to inhale and exhale through the mask body 110 with greater ease. More specifically, when inhaling while wearing the electronic face mask 100, the fan 114 provides the wearer 150 with access to fresh air, which enters through the fan valve and through the mask body 110 including the filter material. When exhaling while wearing the electronic face mask 100, the fan 114 effectively removes the hot and moist expelled breath of the wearer 150, and further helps to prevent the fogging of eyeglasses that may be worn by the wearer 150.

Further, the button 320 may be operated to change the speed of the airflow of the fan 114. As an example, a long press of button 320 may trigger a medium speed of fan 114, or the button 320 may be long pressed consecutively to trigger, for example, a higher fan speed. Further, the smartphone application corresponding to the mask 100 may have a feature for changing the speed or direction of the fan 114, as per the preferences of the user.

Additionally, and as best shown in FIGS. 2 and 3, the adjustable strap assembly 130 is comprised of a first strap 1301, a second strap 1302, and a ladder lock buckle 300. The first strap 1301 is preferably sewn at an end of the top edge 1105 (i.e., the corner), and the second strap 1302 is sewn at an end of the bottom edge 1106 (i.e., the corner). The straps 1301 and 1302 are sewn after they have been looped around the ladder lock buckle 300, and may be secured in place by a series of stiches or other fastening means so that they are affixed to the buckle 300 permanently.

A user 150 may adjust the tightness of all strap assemblies 1301 and 1302 via pulling the straps 1301 or 1302 through or out of the ladder lock buckle 300. Unlike existing tied masks, the strap assembly 130 of the present invention provides a user 150 with a means of securing the electronic airflow face mask 100 to the user's face without requiring a user 150 to tie the straps, which could be an issue for elderly users and/or users with disabilities. In addition, the strap assembly 130 of the present invention has a much lower probability of coming unfastened while in use than a tied mask. Further, the straps 1301, 1302 may be made up of any elastic material, VELCRO® strap or any other material which is flexible and stretchable.

The smartphone application may be a software application which is installable on any compatible electronic device. The electronic device may be a smartphone, a laptop, a tablet, or any other electronic device. The software application may be used to enable different features of the electronic airflow mask 100, and to operate the mask 100 remotely.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electronic airflow mask”, “electronic mask”, “airflow mask” and “mask” are interchangeable and refer to the electronic airflow mask 100 of the present invention.

Notwithstanding the forgoing, the electronic airflow face mask 100 can be any suitable size, shape, and configuration as is known in the art without affecting the overall concept of the invention, provided that it accomplishes the above stated objectives. One of ordinary skill in the art will appreciate that the shape and size of the electronic airflow face mask 100 and its various components, as shown in the FIGS., are for illustrative purposes only, and that many other shapes and sizes of the electronic airflow face mask 100 are well within the scope of the present disclosure. Although the dimensions of the electronic airflow face mask 100 and its components (i.e., length, width, and height) are important design parameters for good performance, the electronic airflow face mask 100 may be any shape or size that ensures optimal performance during use and/or that suits user need and/or preference. This includes differing rigid and non-rigid embodiments of the electronic airflow face mask 100 and their accompanying structures.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic airflow face mask comprising;
a cover having an inner surface and an outer surface;
a first filter material disposed on the inner surface of the cover to trap a particulate material of a first size;
a pair of ear loops, each of the pair of ear loops having a top and a bottom portion;
a first strap attached to the bottom portion of each of the pair of ear loops, wherein the first strap is sized and configured to extend around a back of a head of the wearer; and
a fan disposed on the outer surface of the cover.

2. The electronic airflow face mask of claim 1 further comprising a second filter material disposed adjacent to the first filter material to trap a particulate material larger than the first size.

3. The electronic airflow face mask of claim 1, wherein the first size of particulate material is 0.3 microns or larger.

4. The electronic airflow face mask of claim 2, wherein the first and second filter materials are disposed on the inner surface of the cover.

5. The electronic airflow face mask of claim 2, wherein each of the first and second filter materials is made from a non-woven polypropylene.

6. The electronic airflow face mask of claim 1, wherein the cover blocks 95% of particulate material from passing through the cover.

7. The electronic airflow face mask of claim 1, wherein the cover further comprises a perimeter and a foam or an adhesive seal positioned along the perimeter.

8. The electronic airflow face mask of claim 7, wherein the adhesive seal is comprised of a medical grade sealant.

9. The electronic airflow face mask of claim 1 further comprising a battery, a switch and a controller disposed on the outer surface of the cover.

10. The electronic airflow face mask of claim 9, wherein each of the fan, the battery, the switch and the controller are in electrical communication, and the battery is either a NiMH or a NiCd battery.

11. The electronic airflow face mask of claim 1, wherein the fan can operate in a single direction or a plurality of directions.

12. The electronic airflow face mask of claim 1, wherein the fan is controlled remotely by an application operated from a smart device.

13. A protective facial covering, comprising;
a cover material sized and configured to cover a mouth and nose of a wearer, the cover material having an inner surface, an outer surface, and a perimeter defined by a top edge, a pair of side edges and a bottom edge;
a deformable strip disposed along the perimeter;
a fan disposed along the outer surface of the cover material;
a pair of ear loops, wherein each of the pair of ear loops is connected to one of the pair of side edges and is comprised of a top and bottom;
a first strap and a second strap, wherein the first strap is attached to the top of each of the pair of ear loops and the second strap is attached to the bottom of each of the pair of ear loops; and
at least one filter material applied to the inner surface of the cover material.

14. The protective facial covering of claim 13, wherein a second filter material is provided and is positioned adjacent a first filter material of the at least one filter material.

15. The protective facial covering of claim 13, wherein the fan is in communication with each of a battery, a switch and a controller, and further wherein the battery, the switch and the controller are disposed on the outer surface of the cover material.

16. The protective facial covering of claim 13, wherein the fan is connected to a sensor for detecting at least one of a contamination level, a humidity, and a temperature.

17. The protective facial covering of claim 13 further comprising a chemical sensor.

18. An air flow regulating system for a face mask, comprising;
a cover material having a first and a second filter material that are collectively capable of filtering out at least 95% of a particulate matter having a diameter of at least 0.3 microns, wherein the cover material has a perimeter formed from a top edge, a pair of side edges and a bottom edge;
a strip of foam or adhesive positioned along the perimeter;
a first strap and a second strap connected to a first and a second ear loop for securing the cover material to a face of a wearer, the first and second straps having an adjustable fastening mechanism for tightening or loosening of the first and second straps; and
an air flow regulating system comprised of a fan, a battery, a switch and a controller, wherein the air flow regulating system is controllable by one of manual or remote actuation and is located on an exterior surface of the cover material.

19. The air flow regulating system for a face mask of claim 18, wherein the air flow regulating system further comprises a sensor for detecting at least one of a contamination level, a humidity, and a temperature.

20. The air flow regulating system for a face mask of claim 18, wherein the fan is in electrical communication with the battery.
